(19) United States
(12) Patent Application Publication
(10) Pub. No.: US 2007/0258566 A1
(43) Pub. Date: Nov. 8, 2007

(54) Anti-Scatter-Grid

(75) Inventor: Wolfgang Eckenbach, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/570,105

(22) PCT Filed: Jun. 1, 2005
(86) PCT No.: PCT/IB05/51781

§ 371 Date: Dec. 6, 2006

(30) Foreign Application Priority Data
Jun. 9, 2004 (EP) 04102633.7

(51) Int. Cl. G21K 1/00

(52) U.S. Cl. 378/154

(57) ABSTRACT

The invention relates to an Anti-Scatter-Grid (1) that consists of carrier walls (10) and, transversal thereto, partition walls (20). Noses (22) of the partition walls (20) are inserted into holes (11) of the carrier walls (10) and fixed thereto by laser welding. The noses (22) preferably project from the backside of the carrier walls in order to facilitate welding and alignment. Moreover, various tools are proposed that assist the accurate assembling of the Anti-Scatter-Grid.

The invention comprises an Anti-Scatter-Grid and its components, a detector and an examination apparatus with such an Anti-Scatter-Grid, and assistant tools for the manufacture of such an Anti-Scatter-Grid.

Scattering of X-rays can severely reduce the image quality of X-ray detectors. Anti-Scatter-Grids (ASG) allow transmission of X-rays only in a small angular range, thereby suppressing a large amount of scattered X-rays. In its simplest form such Anti-Scatter-Grids consist of a one-dimensional sandwich array of thin foils of a heavy metal (e.g. W or Mo, thickness 0.1 mm, height 20 mm), separated by a material with low X-ray absorption (e.g. air or plastics, thickness 1 mm). Two-dimensional arrays would give a better efficiency, but are very difficult to produce from metal foils. Several methods have been proposed for this purpose, which up to now suffer from poor quality or stability, high complexity, extreme costs, or unsuitability for small pixel sizes.

Based on this situation it was an object of the present invention to provide a two-dimensional Anti-Scatter-Grid that may readily be produced with high precision.

This object is achieved by an Anti-Scatter-Grid according to claim 1, a carrier wall according to claim 6, a partition wall according to claim 7, a detector according to claim 8, an examination apparatus according to claim 9, and assistant tools according to claims 10, 11, and 13, respectively. Preferred embodiments are disclosed in the dependent claims.

The Anti-Scatter-Grid according to the present invention comprises the following components:
At least two carrier walls that are arranged spaced apart from each other, wherein each carrier wall comprises a plurality of holes. The carrier walls may for example be arranged parallel to each other and extend over the whole width of the Anti-Scatter-Grid, similar to the walls of a conventional one-dimensional ASG. The holes in the carrier walls are preferably arranged in rows, wherein each row comprises at least two such holes.
At least one group of partition walls, wherein said partition walls of the group are arranged spaced apart from each other between two carrier walls and transversal (i.e. at an angle of about 90°) to said carrier walls. The partition walls thus cover the second dimension of a two-dimensional Anti-Scatter-Grid. Typically there is more than one group of such partition walls, wherein each group corresponds to one layer of a two-dimensional Anti-Scatter-Grid. Moreover, each partition wall comprises at least two coupling elements on opposite sides of the partition wall, wherein each coupling element is fixed in a hole of an adjacent carrier wall.

The aforementioned Anti-Scatter-Grid has the advantage that it can be produced from only two types of components, namely the carrier walls and the partition walls. The Anti-Scatter-Grid can be assembled from these components layer by layer, wherein each manufacturing step comprises the addition of one carrier wall and one group of corresponding partition walls to said carrier wall. Due to the holes in the carrier walls, the exact placement and orientation of the partition walls is predetermined.

The carrier walls and/or the partition walls are preferably made from foils or sheets of a heavy metal, for example one with an atomic weight Z>50. The thickness of the metal foils preferably ranges from 0.05 to 0.5 mm, with a typical value being about 0.1 mm. Accurate shapes of the walls can particularly be achieved by laser cutting.

The geometrical arrangement of the carrier walls and the partition walls is mainly predetermined by the shape of these walls and the arrangement of the holes. Typically the walls of the Anti-Scatter-Grid are aligned with respect to a focus point, wherein said focus point may be located at a finite or infinite distance (with the walls being parallel to each other in the latter case).

Preferably each partition wall is fixed with two coupling elements in two corresponding holes of each carrier wall in order to provide a stable connection with a definite orientation.

The coupling elements of the partition walls are preferably noses (protrusions) that extend through the holes in the carrier walls and that project over a little distance from the backside of the carrier walls. Partition walls of this kind must of course also comprise recesses that provide the necessary room for the projecting noses of neighboring partition walls. Said projections of the coupling elements have the advantage that they allow for a mutual alignment of partition walls on opposite sides of a carrier wall and that they provide play for an adjustment of the distance of the carrier walls. Moreover, the projections may be used for permanently fixing the partition wall to the carrier wall.

According to a preferred embodiment the partition walls are permanently fixed to the carrier walls by welding, for example by laser welding. Welding is particularly of advantage in connection with the aforementioned embodiment, where the coupling elements project from the backside of the carrier walls and therefore are easily accessible for welding purposes.

In order to facilitate production of the Anti-Scatter-Grid, the holes in the carrier walls preferably have a tapered introduction section that provides a kind of funnel with a large opening which can easily be hit by a coupling element. The funnel then guides a coupling element to the tighter part of the hole where a kind of press fit of the coupling element in the hole is achieved.

In a similar way, the coupling elements may have a tapered introduction section with a reduced cross section such that their introduction into a hole of a normal (or enlarged) diameter is facilitated.

The invention further comprises a carrier wall for an Anti-Scatter-Grid of the kind mentioned above, i.e. a wall with a plurality of holes to which coupling elements of partition walls can be fixed. Moreover, it comprises a partition wall for such an Anti-Scatter-Grid, i.e. a wall with at least two coupling elements on opposite sides that may be fixed in a hole of a carrier wall. Therefore not only the complete, assembled Anti-Scatter-Grid, but also the components which are dedicated for such an Anti-Scatter-Grid are covered by the protection of the present invention.

Furthermore, the invention relates to a detector for radiation, particularly for X-radiation, comprising an Anti-Scatter-Grid of the kind mentioned above. The Anti-Scatter-Grid of such a detector is typically arranged adjacent to an array of sensor units (pixels) that are sensitive to the radiation which shall be measured.

The invention further comprises an examination apparatus with a source of X-radiation and an X-ray detector that comprises an Anti-Scatter-Grid of the kind described above. The examination apparatus may for example be a SPECT (Single Photon Emission Computed Tomography) or a PET (Positron Emission Tomography) device with the X-ray source being a radioactive substance that is distributed in an object. Alternatively, the examination apparatus may be an X-ray device like a CT-system with the X-ray source being an X-ray tube.

The aforementioned partition walls, carrier walls, detector and examination apparatus are related to an Anti-Scatter-Grid as it was described above. Information on details, advantages and further developments of these objects may therefore be found in the previous description.

The invention further comprises assistant tools for the manufacture of an Anti-Scatter-Grid of the kind mentioned above. The first assistant tool comprises guiding elements with a tapered slot between them that is adapted to guide the coupling element of a partition wall into the hole of a carrier wall. This tool therefore has the effect of a funnel that facilitates the introduction of the coupling elements into the small holes.

Another kind of assistant tool for the manufacture of an Anti-Scatter-Grid (called second/third assistant tool in the “Description of preferred embodiments”) comprises a set of (preferably tapered) spacer elements, wherein each spacer element can be introduced into the space between neighboring partition walls in order to align them. According to an equivalent definition the tool may be described as having notches or grooves into which the partition walls can be introduced, wherein the crests between said notches correspond to the aforementioned spacer elements. This tool may especially be applied after a group of partition walls has been fixed with one side to a carrier wall and before a second carrier wall is placed upon these partition walls. In this case, the alignment of the partition walls is necessary before they are permanently fixed to said carrier wall by welding. Moreover, in the next assembling step the coupling elements of all partition walls must simultaneously be introduced into the holes of the second carrier wall. This difficult process is facilitated by an accurate alignment of the partition walls, which is again achieved by the mentioned assistant tool.

According to a preferred embodiment (called second assistant tool in the “Description of preferred embodiments”), the aforementioned assistant tool may further comprise abutments for a carrier wall that can be used in order to adjust the partition walls with respect to a fixed or a relative reference. A “relative reference” is by definition a reference that changes depending on the place where the assistant tool operates. A typical relative reference is therefore the carrier wall which is contacted by the abutments. On the contrary, a “fixed reference” is independent of the current working site of the assistant tool and may for example be the base of the Anti-Scatter-Grid or an absolute position in the surroundings. A fixed reference has the advantage to avoid an accumulation of positioning errors. The assistant tool with abutments may in particular be used to establish a right angle between carrier and partition walls.

A fourth kind of assistant tool for the manufacture of an Anti-Scatter-Grid comprises at least one gripper for positioning a carrier wall at a predetermined position with respect to a fixed reference point of the Anti-Scatter-Grid, for example its base. This tool has the advantage to avoid an accumulation of positioning errors that may result if the position of each carrier wall is only adjusted with respect to its neighboring carrier wall.

These and other aspects of the invention will be apparent from and elucidated with reference to the embodiment(s) described hereinafter.

### BRIEF DESCRIPTION OF THE DRAWINGS

In the following the invention is described by way of example with the help of the accompanying drawings in which:

FIG. 1 is a perspective view of a partially assembled Anti-Scatter-Grid according to the present invention;

FIG. 2 is a plan view of a part of a carrier wall;

FIG. 3 is a plan view of a partition wall;

FIG. 4 is a section through a carrier wall after the connection of a first and before the connection of a second partition wall;

FIG. 5 is a plan view of a hole with an enlarged entrance;

FIG. 6 is a plan view of a coupling element with a tapered tip;

FIG. 7 is a side view of a first assistant tool for the insertion of partition walls into the holes of a carrier wall;

FIG. 8 is a side view of a partially assembled Anti-Scatter-Grid with a second assistant tool for the alignment of partition walls before they are welded on a first side;

FIG. 9 is a side view of a third assistant tool for the alignment of partition walls that are already fixed on one side;

FIG. 10 is a side view of a partially assembled Anti-Scatter-Grid with a fourth assistant tool for the absolute positioning of a carrier wall before it is welded to the partition walls.

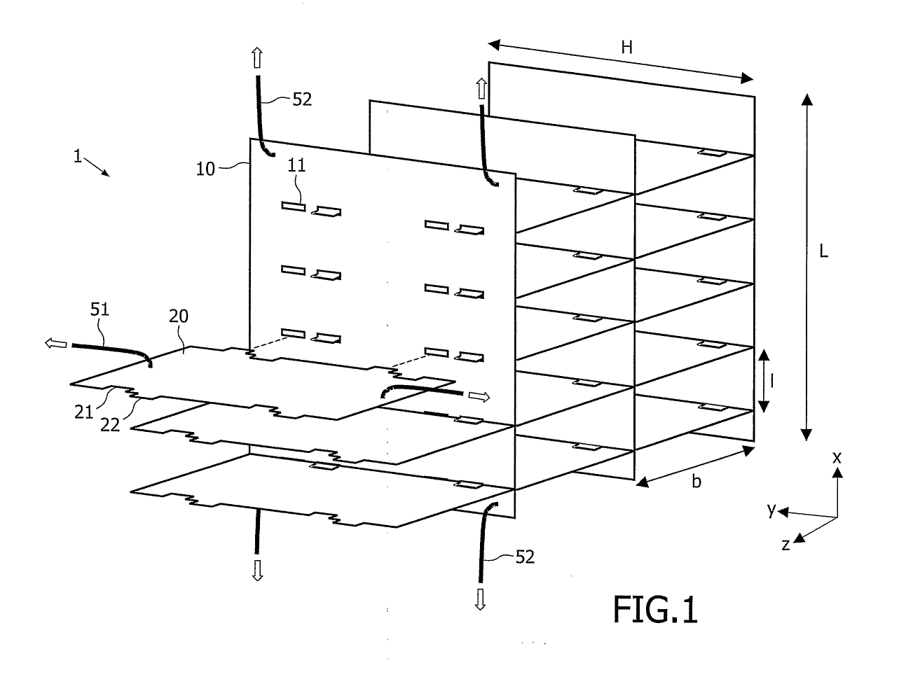

FIG. 1 shows a part of an Anti-Scatter-Grid 1 in a partially assembled state. The grid is called “two-dimensional” because it comprises walls 10, 20 running in two perpendicular directions x, z. These walls constitute a rectangular grid or matrix of channels through which radiation (e.g. X-rays) may pass in direction y to components (e.g. a detector, not shown) that are placed behind the grid. Rays that are not aligned with the channels of the Anti-Scatter-Grid 1 will be absorbed when they hit a wall of the grid. The material of the walls 10, 20 typically is a metal with a high absorption coefficient for the radiation to be filtered, for example a heavy metal like W or Mo in the case of X-rays. Moreover, it should be noted that the Figure only shows a small fraction of an Anti-Scatter-Grid which typically comprises several hundreds or thousands of channels. The height H of the Anti-Scatter-Grid corresponds to the length that rays have to travel through the grid and typically ranges from 20 to 60 mm.

Several methods are known for the production of two-dimensional Anti-Scatter-Grids, for example the casting of lead. Most of these methods have disadvantages like an insufficient precision and/or high costs.

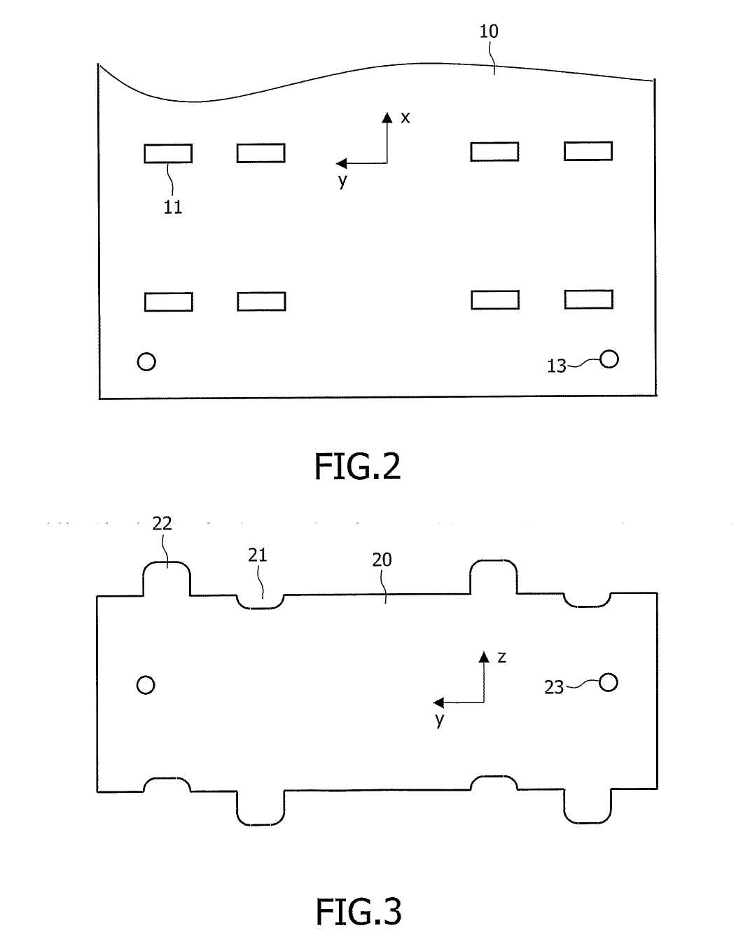

These problems are overcome by an Anti-Scatter-Grid 1 according to the present invention which consists of two kinds of components. The first kind of component are the so-called carrier walls 10 (see also FIG. 2) which extend in x-direction (vertically in the representation of FIG. 1) across the whole width L of the Anti-Scatter-Grid and which are arranged parallel to each other and spaced apart from each other in z-direction (horizontal in FIG. 1) by a distance b. The carrier walls 10 comprise horizontal rows with four holes 11 each, the rows being spaced apart by a distance 1.

The second component of the Anti-Scatter-Grid 1 are the partition walls 20 which are oriented horizontally in FIG. 1. Between each pair of carrier walls 10, a group of horizontal partition walls 20 is arranged with the partition walls being spaced apart from each other by the distance 1 and parallel to each other. The partition walls 20 have two coupling elements on each side in the form of protrusions or noses 22 which can be inserted into the holes 11 of the carrier walls 10. The Anti-Scatter-Grid 1 can thus be assembled layer by layer, wherein FIG. 1 depicts a state in which two layers have already been completely assembled and in which the assembling of a third layer is in progress.

The carrier walls 10 and the partition walls 20 may be produced by laser cutting from metal foil, which provides very high accuracy to these pieces. Moreover, the walls may be fixed with respect to each other by laser welding, which maintains the accuracy and inherent stability of the components.

FIG. 2 shows a part of a carrier wall 10 in more detail. The four holes 11 of each row are arranged near the (left and right) borders of the carrier wall 10 in pairs of two in order to fix the partition walls at their ends. Moreover, the carrier wall 10 optionally has a hole 13 in each corner in which hooks 52 (FIG. 1) may be fastened in order to be able to transport, manipulate and stretch the walls 10 during assembling. After mounting, the holes 13 may serve for the connection of the whole Anti-Scatter-Grid 1 to a detector.

FIG. 3 shows a partition wall 20 in more detail. The partition wall comprises two noses 22 on each side, wherein there is always a corresponding recess 21 on the other side opposite to a nose 22. The whole shape of the partition wall 20 is invariant with respect to rotations of 180° about an axis vertical to the plane of the drawing. The partition wall 20 optionally has at least two holes 23 on opposite sides in which hooks 51 (FIG. 1) may be fastened in order to be able to transport, manipulate and stretch the walls 20 during assembling.

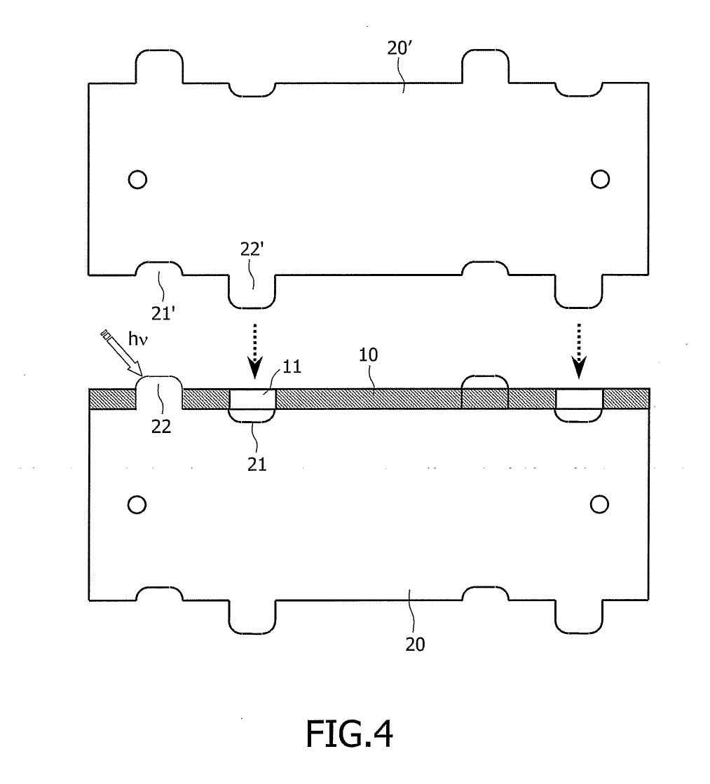

FIG. 4 shows a section through a carrier wall 10 at the height of a row of holes 11. In the depicted state of the assembling process, the lower partition wall 20 has already been inserted with its noses 22 into the corresponding holes 11 of the carrier wall 10. The length of the noses 22 is a little bit (typically 100 μm to 500 μm, preferably about 200 μm) larger than the thickness of the carrier wall 10, such that the noses 22 protrude from the backside of the carrier wall. This protrusion may be exploited for a vertical alignment with a partition wall 20′ that will be fixed to the backside of the carrier wall 10. Moreover, the protrusions may be used as sites where a permanent fixing of the partition wall 20 to the carrier wall 10 is achieved by laser welding (see arrow hv). A slight ripple of the foils that form the walls may be corrected this way, too. Finally, the oversize of the noses 22 gives some freedom or play in the positioning of the carrier walls 20 in z-direction which may be used for their positional adjustment.

In order to avoid collision of a partition wall 20 with the protrusions 22′ of a partition wall 20′ on the opposite side of the carrier wall 10 and vice versa, the partition walls 20, 20′ comprise the aforementioned recesses 21, 21′ at the corresponding locations.

In the embodiment shown in FIG. 1, all carrier walls 10 are parallel to each other and all partition walls 20 are parallel to each other. Thus, the Anti-Scatter-Grid 1 is adapted to let only parallel rays pass. The arrangement of the holes 11 and the shape of the partition walls 20 may however also be chosen such that the channels of the Anti-Scatter-Grid are focused to a point at a finite distance, for example to the position of an X-ray tube.

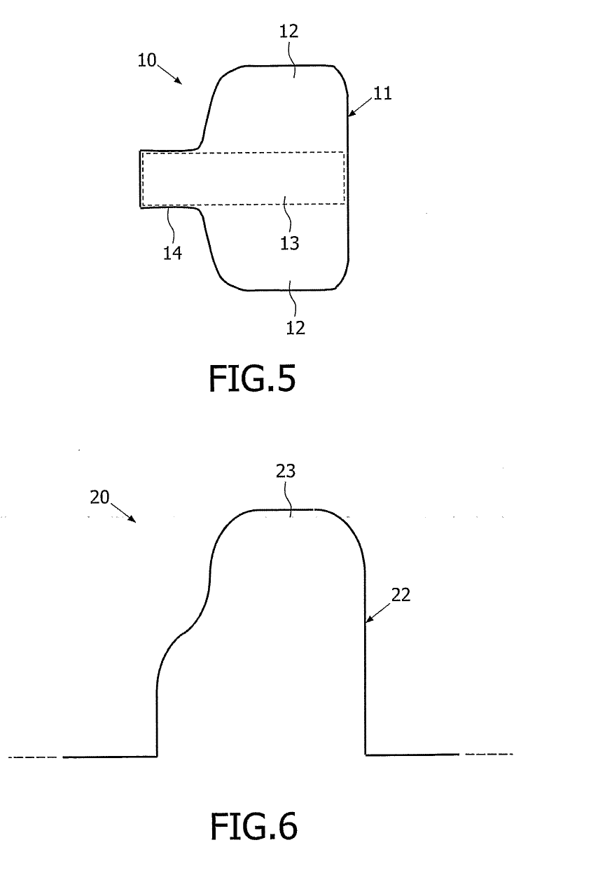

During the assembling of an Anti-Scatter-Grid of the kind described above, a difficult step will be the insertion of the small noses 22 of the partition walls 20 into the holes 11 of the carrier walls 10. In order to facilitate this process, the holes 11 in the carrier walls may be provided with an enlarged cross section at their entrance, as is shown in FIG. 5. The enlargement provides a tapered introduction section 12 that leads to a narrower rectangular fitting section 13 and has a capturing effect like a funnel. As can be seen from FIG. 5, only a part of the hole 11 has an enlarged entrance, while the rest forms a fitting section 14 which guarantees the good adjustment of an inserted nose.

FIG. 6 shows a nose 22 of a partition wall 20 that is adapted to be inserted into a hole 11 of the kind shown in FIG. 5. The nose 22 has a smaller or tapered tip 23 that may be easily caught by the introduction section 12 of the hole 11 in FIG. 5.

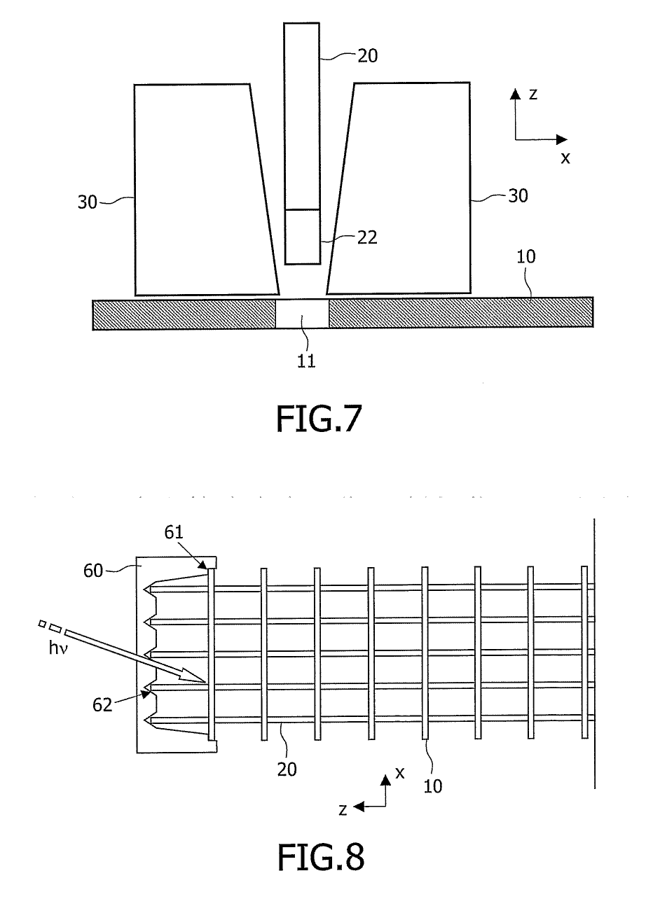

Moreover, an assistant tool for the insertion of the noses 22 of partition walls 20 into the holes 11 of carrier walls 10 is shown in FIG. 7. This first assistant tool consists of two wedges 30 that form the boundary of a tapered slot, wherein the slot guides a partition wall 20 into the small holes 11.

When the third layer of partition walls 20 in FIG. 1 has been loosely mounted to the last carrier wall 10, the partition walls 20 are permanently fixed to the carrier wall 10 by laser welding. Before this can take place, however, the correct alignment of the partition walls 20 must be achieved. FIG. 8 shows a second kind of assistant tool 60 that is suited for this purpose. This tool 60 has notches 62 for the accommodation of a partition wall 20 each. If all partition walls 20 are disposed in their corresponding notch, an equal spacing of these walls is guaranteed. Furthermore, the tool 60 has abutments 61 at its ends which come into contact with the edges of the corresponding carrier wall 10, thus providing an orthogonal orientation between carrier and partition walls. Additionally or alternatively, there might be abutments (not shown) which contact a fixed point of the grid, e.g. the first (rightmost) carrier wall, or an absolute point in space in order to avoid a possible accumulation of errors. Moreover, the tool 60 must be sufficiently small in y-direction in order to allow laser rays hv to reach the foot points of the partition walls 20 for permanently fixing them to the carrier wall 10 by laser welding. There could for example be several thin tools 60 placed apart from each other in y-direction, or a one-piece tool 60 could be provided with holes for the transmission of laser rays.

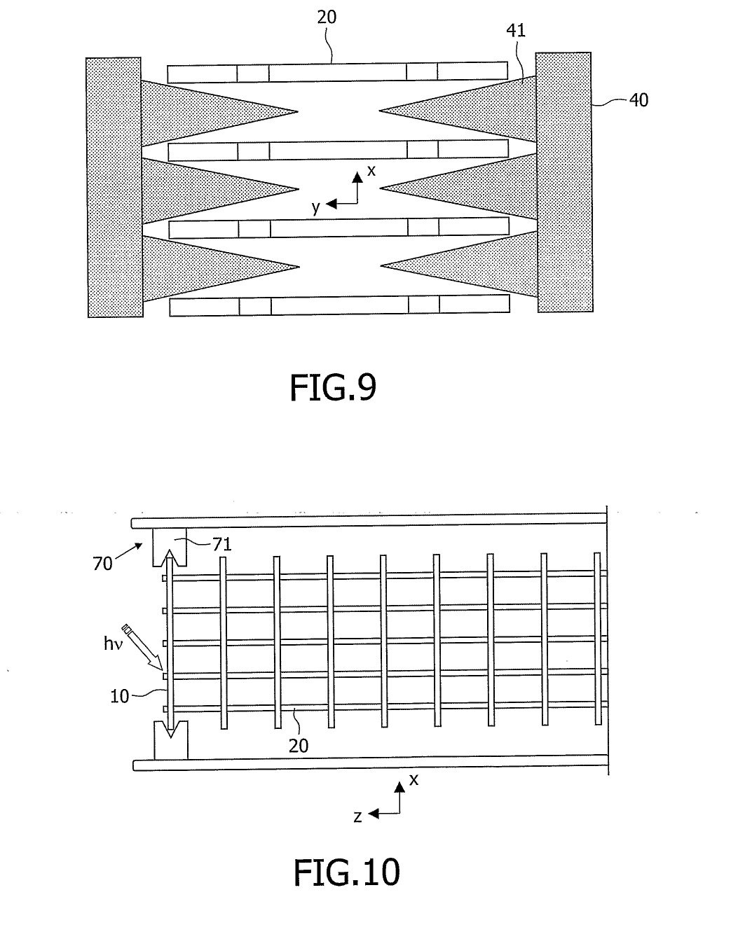

After the third layer of partition walls 20 in FIG. 1 has been mounted and fixed to the last carrier wall 10, the next carrier wall (not shown) must be placed upon these partition walls. In this state, the partition walls 20 may still move independently a little bit, which makes the required insertion of their free noses 22 into the holes of the next carrier wall difficult. This problem may be overcome by a third kind of assistant tool 40 which is shown in FIG. 9. The assistant tool 40 comprises two sets of tapered spacer elements 41 which are disposed next to each other in a line and which may be inserted like the teeth of a comb into the spaces between the partition walls 20 in order to adjust and fix their mutual distances. After all partition walls 20 have been aligned in this way, the next carrier wall 10 may readily be placed upon them.

FIG. 10 shows the Anti-Scatter-Grid after the aforementioned placement of the last carrier wall 10 onto the partition walls 20. Said carrier wall 10 shall now be fixed to the partition walls 20 by laser welding (arrow hv) at the noses that project from its backside. The correct distance b of the carrier wall 10 from its neighboring carrier wall can be controlled by a spacer element introduced between these walls. In this case, however, small errors in the relative distance of neighboring walls could accumulate from layer to layer to a considerable amount. In order to prevent such accumulation of errors, the fourth assistant tool 70 is used which comprises at least one, preferably several grippers 71 that fix the last carrier wall 10 at a predetermined z-position with respect to a reference point that is common to the whole Anti-Scatter-Grid, for example the boundary of the grid opposite to the carrier wall 10 to be positioned.

It is not necessary to apply the aforementioned fourth assistant tool 70 to each carrier wall. Instead, it may suffice to use it only from time to time, e.g. for the accurate positioning of each tenth carrier wall. The other carrier walls may then be mounted in a usual way as close to each other as possible, i.e. with the noses 22 completely inserted into the corresponding holes 11, which yields a structure with a high stability. In contrast to this, the carrier walls that are positioned accurately with the assistant tool 70 typically rest somewhere in an intermediate position on the noses 22. In order to improve stability and/or adaptability for the accurately positioned carrier walls, reinforced and/or extended noses could be provided at the corresponding partition walls.

Instead of laser welding for the permanent fixing of the Anti-Scatter-Grid, of course other methods like bonding could be used.

The Anti-Scatter-Grid 1 described above has a number of advantages with respect to embodiments known from the state of the art:
A high precision of typically better than 5 μm according to the accuracy of laser cutting.
Minimal wall thickness and therefore a high specific X-ray absorption as the walls are built from smooth and not-deformed foils.
Little weight and high mechanical stability due to a great number of laser welding points.
Improved flatness of the walls over extended distances.
No need for high processing temperatures of the whole Anti-Scatter-Grid that might lead to tensions and deformations during cooling.
No need for a thick frame around the hole Anti-Scatter-Grid.
Mounting tools with high precision are only needed one times and must not remain at the Anti-Scatter-Grid.
A small number of only two principal components.
Very simple combination with a detector via precise mounting drillings (13) directly at the walls of the Anti-Scatter-Grid. Optionally, single (carrier) walls with a larger length may be used for this purpose.
Anti-Scatter-Grids with a large height, for example 60 mm instead of 20 mm, may be produced without much additional effort. If necessary, more than two laser welding points per partition wall may be applied in order to guarantee the flatness and stability. Hooks coupled to the ends of a partition wall may straighten a corrugated partition wall if necessary.

Finally it is pointed out that in the present application the term “comprising” does not exclude other elements or steps, that “a” or “an” does not exclude a plurality, and that a single processor or other unit may fulfill the functions of several means. Moreover, reference signs in the claims shall not be construed as limiting their scope.

1. An Anti-Scatter-Grid, comprising
carrier walls that are arranged spaced apart from each other and that comprise a plurality of holes;
at least one group of partition walls, wherein said partition walls are arranged spaced apart from each other between and transversal to two carrier walls and wherein each partition wall comprises at least two coupling elements on opposite sides that are fixed in a hole of one of the two carrier walls each.

2. The Anti-Scatter-Grid according to claim 1, wherein the coupling elements are noses that extend through the holes and project from the corresponding backsides of the carrier walls.

3. The Anti-Scatter-Grid according to claim 1, wherein the partition walls are permanently fixed to the carrier walls by welding.

4. The Anti-Scatter-Grid according to claim 1, wherein the holes in the carrier walls have a tapered introduction section.

5. The Anti-Scatter-Grid according to claim 1, wherein the coupling elements have a tapered introduction section.

6. A carrier wall for an Anti-Scatter-Grid according to claim 1.

7. A partition wall for an Anti-Scatter-Grid according to claim 1.

8. A detector for radiation, particularly X-radiation, comprising an Anti-Scatter-Grid according to claim 1.

9. An examination apparatus, comprising a source of X-radiation and an X-ray detector according to claim 9.

10. An assistant tool for the manufacture of an Anti-Scatter-Grid according to claim 1, comprising guiding elements that define a tapered slot which guides the coupling elements of a partition wall into the hole of a carrier wall.

11. An assistant tool for the manufacture of an Anti-Scatter-Grid according to claim 1, comprising an arrangement of spacer elements that can be introduced into the space between neighboring partition walls in order to align them.

12. The assistant tool according to claim 11, wherein it comprises abutments (for a carrier wall for the adjustment of the partition walls with respect to a fixed or a relative reference point.

13. An assistant tool the manufacture of an Anti-Scatter-Grid according to claim 1, comprising at least one gripper for positioning a carrier wall at a predetermined distance with respect to a fixed reference point of the Anti-Scatter-Grid.
